(19) United States
(12) Patent Application Publication
(10) Pub. No.: US 2003/0138595 A1
(43) Pub. Date: Jul. 24, 2003

(54) Mat & process for manufacturing mats

(76) Inventor: Terence Michael Hedley, Bedfordshire (GB)

Correspondence Address: Allan Ratner, RatnerPrestia, One Westlakes Berwyn Suite 301, PO Box 980, Valley Forge, PA, 19482-0980, US

(21) Appl. No.: 10/296,632

(22) PCT Filed: May 18, 2001
(86) PCT No.: PCT/GB01/02178

(30) Foreign Application Priority Data
May 25, 2000 (GB) 0012722.5

(51) Int. Cl. B32B 33/00; D03D 27/00; D05C 17/00; D04H 11/00; B32B 3/02

(52) U.S. Cl. 428/92

(57) ABSTRACT

A mat has a fabric layer (2) including a substrate (8) a tufted pile (6), and a rubber backing (4). The fabric layer (2) includes tufts of a blended yarn (12) that includes a moisture absorbing fibre and a fibre having anti-microbial properties, and optionally a low melting point fibre that is at least partially fused to the other fibres in the blended yarn. The tufted pile (6) may also optionally include tufts of twisted synthetic yarn (10).

This invention relates to mats and in particular, but not exclusively, to washable dust control mats, in which a rubber backing sheet is cured and heat-bonded under pressure to the back of a fabric layer. It also relates to a process for manufacturing mats.

The term “washable” means washable by immersion and agitation in water or other cleaning fluid usually followed by spin extraction and tumble drying. The term “mat” is used hereinafter in a wide sense to include rugs and carpets.

Manufacturers of washable rubber backed dust control mats sell their mats to the textile rental industry who then rent or sell the mats to the end users such as shops, factories, hospitals etc. The mats are placed at the entrances of buildings and serve to remove dirt and moisture from the feet of pedestrians entering the buildings. On a weekly, two weekly or monthly cycle the dirty mats are collected and returned to the laundry for washing and replaced with clean mats.

It is normal for a laundry to purchase a number of types of mats to deal with the variety of soiling types and end users. The common types of mat are as follows:

A. Cotton Mats: In general, these are mats of low aesthetic appeal but with very good moisture, grease and oil absorbing properties. The mats have low particulate soil absorption properties as the dense closed structure of the pile only allows the dirt to remain on the surface. They are also susceptible to the growth of mildew. This type of mat is usually seen in industrial locations and in entrances other than the main high profile entrances of shops, offices, factories etc.

B. High Twist Nylon Mats: These mats utilise a high twist nylon pile and are harder wearing and generally more aesthetically pleasing than cotton pile mats. The mats are therefore usually placed at the high profile entrances to premises and can be colour coordinated with the decoration and may have a message or advertisement written on them. The mats have very good particulate soiling absorption properties and maintain their appearance longer than other mat types, as the soiling is absorbed into and hidden within the pile. These mats only have limited moisture and oil absorption properties.

C. Scraper Mats: These mats have a pile that is manufactured from 100% nylon or polyester monofilament, or a combination of monofilament and high twist nylon pile. This type of mat can be placed outside the entrance of a building to enable people to wipe their feet to remove particulate soiling. The mats have little or no moisture absorbing properties and are usually complemented by a second mat of cotton or High Twist Nylon immediately inside the entrance to remove moisture from pedestrians' shoes.

Our European patent application No. 99111535.3 describes a dust control mat that includes a mixture of yarns, including cotton for moisture absorption, high twist nylon for dirt retention and nylon monofilaments to provide a scraping effect. Although that mat provides a good combination of characteristics, we have found that there are practical difficulties in bonding the nylon monofilaments to the rubber backing, and there is a tendency for the cotton to lint when the mat is washed with ordinary nylon mats. Furthermore, we have found that under circumstances where the mat remains wet for prolonged periods, the growth of mildew can be problematic.

It is an object of the invention to provide a mat and a process for manufacturing mats that mitigates at least some of the disadvantages with the aforesaid mats.

According to a first aspect of the present invention there is provided a mat having a tufted fibre layer including a substrate and a tufted pile; characterised in that the tufted pile includes a moisture absorbing fibre and a fibre having anti-microbial properties.

Such a mat has good moisture absorbing properties and also resist the growth of mildew.

Advantageously, the moisture absorbing fibre is a cotton fibre, and is preferably Strict Middling Cotton.

Advantageously, the fibre having antimicrobial properties is an acrylic fibre that includes an antimicrobial agent. The acrylic fibre may have a decitex in the range 1.7-15.0 decitex, preferably 1.7 decitex.

Advantageously, the fibre having anti-microbial properties and the moisture absorbing fibre are combined in a blended yarn. The blended yarn may include a low melting point fibre that is at least partially fused to the other fibres in the blended yarn.

Advantageously, the low melting point fibre is a low melting point polyester fibre, having a melting temperature in the range 80-200C, preferably approximately 110C. The polyester fibre may have a decitex in the range 0.85-17.0 decitex, preferably approximately 4.4 decitex.

Advantageously, the moisture absorbing fibre comprises from 25% to 50%, and preferably from 35% to 40%, and more preferably approximately 40%, of the content of the blended yarn.

Advantageously, the fibre that has antimicrobial properties comprises from 25% to 50%, and preferably from 35% to 40%, and more preferably approximately 40%, of the content of the blended yarn.

Advantageously, the low melting point fibre comprises from 10% to 40%, and preferably from 20% to 30%, and more preferably approximately 20%, of the content of the blended yarn.

Advantageously, the blended yarn has between 2 and 10 plies, and is preferably a 6-ply yarn. The blended yarn may be an open end spun or ring spun yarn. The blended yarn may have a count in the range 2-10 English Cotton count, preferably 7.5 English Cotton Count.

Advantageously, the tufted pile includes a twisted synthetic yarn. The twisted synthetic yarn may be a high twist nylon yarn. The twisted synthetic yarn may be a two ply twisted and heat set yarn. The twisted synthetic yarn may be a yarn of solution-dyed Nylon 6. The count of the twisted synthetic yarn may be in the range 1000 to 5000 decitex, and is preferably approximately 1300 decitex.

Advantageously, the ratio of twisted synthetic yarn tufts to blended yarn tufts in the fibre layer is in the range 6:1 to 1:6, and preferably from 2:1 to 1:2, more preferably approximately 1:1.

Advantageously, the tufted fibre layer includes a substrate of non-woven polyester.

Advantageously, the tufted fibre layer is bonded to a rubber backing layer.

Advantageously, the mat is a washable dust control mat.

According to a preferred embodiment of the present invention there is provided a mat having a tufted fibre layer including a substrate and a tufted pile that includes a first yarn and a second yarn, characterised in that the first yarn is a twisted synthetic yarn and the second yarn is a blended yarn that includes a moisture absorbing fibre, a fibre having anti-microbial properties and a low melting point fibre, wherein the low melting point fibre is at least partially fused to the other fibres in the blended yarn.

We have found that by partially fusing the low melting point fibre to the other fibres in the blended yarn, linting of cotton fibres from the yarn can be prevented, while the inclusion of a fibre having anti-microbial properties effectively prevents the growth of mildew. Further, we have found to our surprise that the partially fused yarn provides a good scraping effect, so avoiding the need for a thick, monofilament yarn. The mat is therefore much simpler to manufacture than previous mats.

The twisted synthetic yarn, which may for example be a high twist nylon yarn, provides good dirt retention properties, durability and a smart appearance, and the cotton provides for good moisture absorption. The mat therefore provides a good balance of characteristics including effective dirt removal and retention, good moisture absorbing properties, mildew resistance, durability and a smart appearance.

According to a further aspect of the invention there is provided a process for manufacturing mats, in which a moisture absorbing fibre and a fibre having anti-microbial properties are tufted onto a substrate to produce a tufted fibre layer.

Advantageously, the fibre having anti-microbial properties and the moisture absorbing fibre are combined in a blended yarn that includes a low melting point fibre, and the mat is pressed in a heated press to fuse the low melting point fibre at least partially to the other fibres in the blended yarn, and the pressed mat is laundered to raise the pile of the fabric layer.

According to a preferred embodiment of the invention there is provided a process for manufacturing mats, in which a first yarn and a second yarn are tufted onto a substrate to produce a tufted fibre layer, wherein said first yarn is a twisted synthetic yarn and the second yarn is a blended yarn that includes a moisture absorbing fibre, a fibre having anti-microbial properties and a low melting point fibre, characterised in that the mat is pressed in a heated press to fuse the low melting point fibre at least partially to the other fibres in the blended yarn, and the pressed mat is then laundered to raise the pile of the fabric layer.

Advantageously, the fabric layer is bonded to a rubber backing layer in the heated press. The press may be heated to a temperature in the range 150-200C, preferably approximately 170C. The mat may be pressed in the heated press for a time in the range 4-30 minutes, preferably approximately 20 minutes.

Advantageously, the mat includes the features of at least one of the preceding statements of invention.

According to a further aspect of the invention there is provided a mat made by a process according to any one of the preceding statements of invention, wherein said mat has a substrate and a tufted pile, characterised in that the tufted pile includes a moisture absorbing fibre and a fibre having anti-microbial properties.

According to a preferred embodiment of the invention there is provided a mat made by a process according to any one of the preceding statements of invention, wherein said mat has a tufted fibre layer including a substrate and a tufted pile that includes a first yarn and a second yarn, characterised in that the first yarn is a twisted synthetic yarn and the second yarn is a blended yarn that includes a moisture absorbing fibre, a fibre having anti-microbial properties and a low melting point fibre, wherein the low melting point fibre is at least partially fused to the other fibres in the blended yarn.

Embodiments of the invention will now be described, by way of example, with reference to the accompanying drawings, in which:

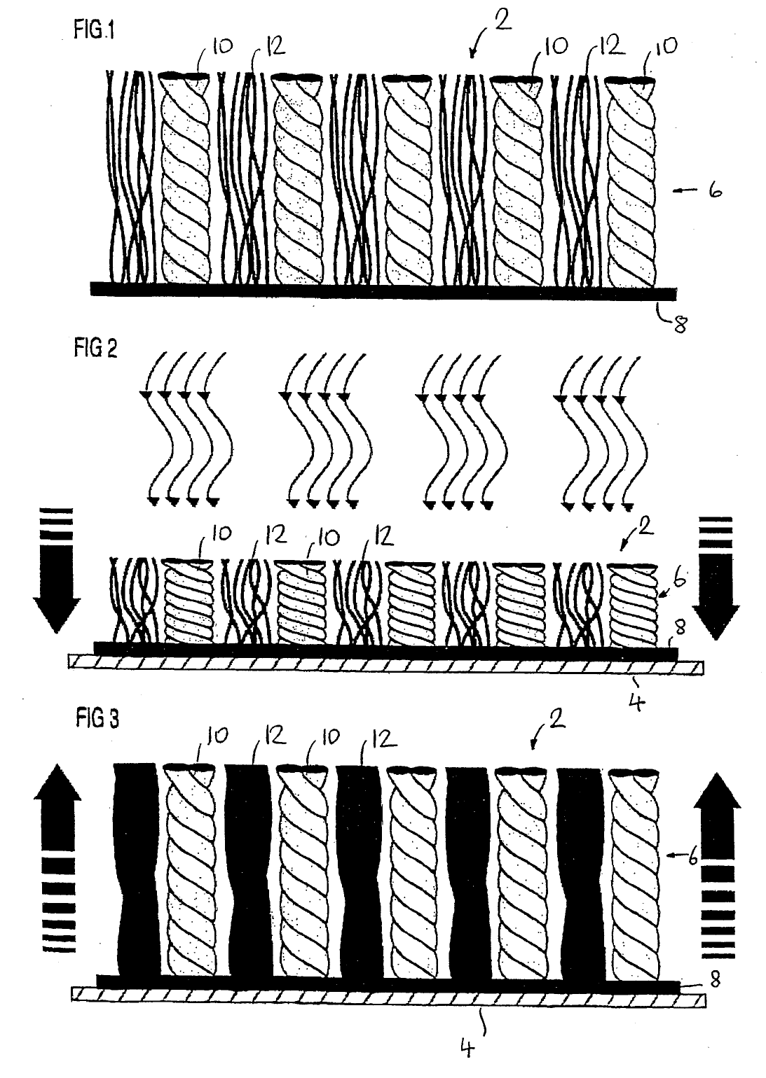

FIG. 1 is a partial side section through a laid-up dust control mat, prior to the pressing operation,

FIG. 2 is a partial side section through a manufactured dust control mat, after the pressing operation but prior to laundering, and

FIG. 3 is a partial side section through a finished dust control mat, after laundering.

The finished mat, which is shown in FIG. 3, has a fabric layer 2 and a rubber backing 4. The fabric layer 2 includes a tufted pile 6, which is tufted onto a substrate 8 (or primary backing). The fabric layer 2 is bonded to the rubber backing 4 through the application of heat and pressure.

The rubber backing 4 consists for example of nitrile rubber, having a thickness in the range 1-5 mm, preferably approximately 1.52 mm.

The substrate 8 consists, for example, of woven or non-woven polyester or polypropylene of density between 70 and 300 g/m². In the preferred example we use a non-woven polyester substrate of density 100 g/m²

The tufted pile 6 can be cut, looped or both, and typically consists of cut pile. The tufted pile is made up from two yarn types, these being:

A: a first yarn 10 of high twist nylon, and

B: a blended yarn 12 that includes a moisture absorbing fibre, a fibre having anti-microbial properties, and a low melting point fibre. The low melting point fibre is at least partially fused so as to bond the blended yarn together.

More specifically, the fibres making up the blended yarn 12 may be as follows:

1. The low melting point fibre may, for example, be a low melting point polyester fibre, having a melting temperature in the range 80-200C, preferably approximately 110C. The count of the low melting point polyester may be in the range 0.85-17.0 decitex and is preferably approximately 4.4 decitex.

2. The moisture absorbing fibre may be cotton, and is preferably Strict Middling Cotton.

3. The fibre having anti-microbial properties may be an acrylic fibre that includes an antimicrobial agent, for example an antibacterial agent such as TRICLOSAN and/or an antifungal agent. In particular, the fibre may be an acrylic fibre of the type sold under the trade mark AMICOR PLUS by Acordis Acrylic Fibres of Bradford, Great Britain. This fibre has antimicrobial properties and imparts mildew resistance to the yarn. The decitex of the fibre may be in the range 1.7 to 15.0 decitex and is preferably 1.7 decitex.

The blended yarn 12 may have from 2 to 10 plies, preferably 6 plies, a count in the range 2 to 10 English Cotton Count, preferably approximately 7.5 English Cotton Count, and may be open end spun or ring spun.

The high twist synthetic yarn 10 may for example be a two ply yarn of 1300 Decitex with an inserted twist level of 195 twists per metre and heat set. However, other 1, 2, 3 or 4 ply yarns ranging in count from 1000 to 4500 Decitex with single fibre counts of the order 15 to 100 dernier per filament may also be used.

By combining the high twist nylon yarn with the blended and partially fused yarn, it is possible to create a tufted pile with the following properties:

1. increased scraping effect compared to a cotton or high twist nylon pile,

2. increased moisture absorption compared to a high twist nylon or scraper mat,

3. increased particulate soil absorption compared to a cotton mat, and

4. antimicrobial properties.

The method of manufacturing the mat is as follows. First, the fabric layer 2 is made up by tufting the high twist nylon yarn 10 and the blended yarn 12 onto the substrate 8, to form the tufted pile 6. The tufting machine may for example be creeled as follows:

ABABABAB etc.

where A is the high twist nylon yarn 10, and B is the blended yarn 12. This produces a 1 in 2 tufted pile with one tuft of high twist nylon yarn to one tuft of blended yarn (i.e. a ratio of 1:1).

The fabric layer 2 is then laid up on a backing layer 4 of uncured rubber, prior to being placed in a heated press. The laid up mat is shown in FIG. 1. The laid up mat may be covered by top and bottom release sheets (not shown), for example of PTFE-coated woven glass, to prevent it sticking to the press.

The laid-up mat is then pressed in a heated press (not shown), for example of the type having a heated metal platen and a diaphragm that may be inflated to press the mat against the platen. The mat may be pressed for example at a temperature of 170° C. and a pressure of 30 pounds per square inch, applied for a cycle time of twenty minutes. The heat from the press bonds the fabric layer 2 to the rubber backing 4 and vulcanises the rubber of the backing layer 4. Optionally, a metal frame (not shown) may be placed in the press with the mat to create a reinforced border around the rubber backing layer 4, as described in our European patent application No. 96928592.3, the content of which is incorporated by reference herein.

The heat from the press partially melts the low melting point fibre in the blended yarn 12 and fuses it to the other fibres in that yarn. The pressing operation also has the effect of flattening the pile 6, so that the mat appears as shown in FIG. 2 when removed from the press.

After pressing and completion of any other necessary manufacturing processes such as trimming the edges of the rubber backing layer 4 (which processes are standard and will not be described in detail here), the mat is laundered by immersion and agitation in water or other cleaning fluid, followed by spin extraction and tumble drying. This process raises the flattened pile so that the finished mat has the appearance shown in FIG. 3.

The partially fused tufts of blended yarn in the finished mat are relatively stiff and provide an effective scraping action, while the cotton fibres provide good moisture absorption. The high twist nylon tufts provide good dirt retention. The mat also resists mildew well, owing to the presence of the antimicrobial acrylic fibres.

Some fibre blends that have been successfully used to make tufted mats according to the invention are given below:

| | |
|---|---|
| 1. 30% polyester / 35% cotton / 35% acrylic: | open end spun |
| 2. 20% polyester / 40% cotton / 40% acrylic: | open end spun |
| 3. 20% polyester / 40% cotton / 40% acrylic: | open end spun - higher |
| | twist in singles |
| 4. 20% polyester / 40% cotton / 40% acrylic: | ring spun |

A typical tufting specification may be as follows:

| | |
|---|---|
| High twist nylon content: | 327 g/m². |
| Blended yarn content: | 517 g/m². |
| Total pile weight: | 844 g/m². |

Various modifications of the invention are of course possible. For example, the tufted pile may include a higher or lower ratio of blended yarn to high twist synthetic yarn, to provide a different balance of properties. The ratio may for example vary from 6:1 to 1:6, but is preferably in the range 1:2 to 2:1 and is more preferably close to equality. The ratio of fibre types in the blended yarn may also be adjusted, according to the requirements of the mat. The mat may be dyed as a whole, or printed, or made of yarns of different colours to produce a pattern or colour.

Further, it is envisaged that the tufted pile may include only a moisture absorbing fibre and a fibre having anti-microbial properties. Such a mat has good moisture absorbing properties and also resists the growth of mildew.

The moisture absorbing fibre may be a cotton fibre, for example Strict Middling Cotton, and the fibre having antimicrobial properties may be an acrylic fibre that includes an antimicrobial agent. The acrylic fibre may have a decitex in the range 1.7-15.0 decitex, preferably 1.7 decitex.

The fibre having anti-microbial properties and the moisture absorbing fibre may be combined in a blended yarn. The blended yarn may also include a low melting point fibre that is at least partially fused to the other fibres in the blended yarn. The low melting point fibre may for example be a low melting point polyester fibre, having a melting temperature in the range 80-200C, preferably approximately 110C. The polyester fibre may have a decitex in the range 0.85-17.0 decitex, preferably approximately 4.4 decitex.

The blended yarn may include the following fibre content:

| | |
|---|---|
| moisture absorbing fibre: | from 25% to 50%, preferably from 35% to 40%, and more preferably |
| | approximately 40%. |
| antimicrobial fibre: | from 25% to 50%, preferably from 35% to 40%, and more preferably |
| | approximately 40%. |
| low melting point fibre | from 10% to 40%, preferably from 20% to 30%, and more preferably |
| | approximately 20%. |

The blended yarn has between 2 and 10 plies, and is preferably a 6 ply yarn. The blended yarn may be an open end spun or ring spun yarn. The blended yarn may have a count in the range 2-10 English Cotton count, preferably 7.5 English Cotton Count.

1. A mat having a tufted fibre layer including a substrate and a tufted pile; characterised in that the tufted pile includes tufts of a first yarn and tufts of a second yarn, wherein the first yarn is a twisted synthetic yarn, and the second yarn is a blended yarn that includes at least three different fibres, including a moisture absorbing fibre, a fibre having anti-microbial properties and a low melting point fibre, and wherein the low melting point fibre is a low melting point polyester fibre that has a melting temperature of approximately 110C and is at least partially fused to the moisture absorbing fibre and the fibre having anti-microbial properties.

2. A mat according to claim 1, wherein the moisture absorbing fibre is a cotton fibre.

3. A mat according to claim 2, wherein the cotton fibre is Strict Middling Cotton.

4. A mat according to any one of the preceding claims, wherein the acrylic fibre has a decitex in the range 1.7-15.0 decitex, preferably 1.7 decitex.

5. A mat according to any one of the preceding claims, wherein the fibre having anti-microbial properties is an acrylic fibre that includes an antimicrobial agent.

6. A mat according to any one of the preceding claims, wherein the polyester fibre has a decitex in the range 0.85-17.0 decitex, preferably approximately 4.4 decitex.

7. A mat according to any one of the preceding claims, wherein the low melting point fibre comprises from 10% to 40%, and preferably from 20% to 30%, and more preferably approximately 20%, of the content of the blended yarn.

8. A mat according to any one of the preceding claims, wherein the moisture absorbing fibre comprises from 25% to 50%, and preferably from 35% to 40%, and more preferably approximately 40%, of the content of the blended yarn.

9. A mat according to any one of the preceding claims, wherein the fibre that has antimicrobial properties comprises from 25% to 50%, and preferably from 35% to 40%, and more preferably approximately 40%, of the content of the blended yarn.

10. A mat according to any one of the preceding claims, wherein the blended yarn has between 2 and 10 plies, and is preferably a 6 ply yarn.

11. A mat according to any one of the preceding claims, wherein the blended yarn is an open end spun or ring spun yarn.

12. A mat according to any one of the preceding claims, wherein the blended yarn has a count in the range 2 to 10 English Cotton Count, preferably 7.5 English Cotton Count.

13. A mat according to any one of the preceding claims, wherein the twisted synthetic yarn is a high twist nylon yarn.

14. A mat according to any one of the preceding claims, wherein the twisted synthetic yarn is a two ply twisted and heat set yarn.

15. A mat according to any one of the preceding claims, wherein the twisted synthetic yarn is a yarn of solution-dyed Nylon 6.

16. A mat according to any one of the preceding claims, wherein the count of the twisted synthetic yarn is in the range 1000 to 5000 decitex, and is preferably approximately 1300 decitex.

17. A mat according to any one of the preceding claims, wherein the ratio of twisted synthetic yarn tufts to blended yarn tufts in the fibre layer is in the range 6:1 to 1:6, and preferably from 2:1 to 1:2, more preferably approximately 1:1.

18. A mat according to any one of the preceding claims, wherein the tufted fibre layer includes a substrate of non-woven polyester.

19. A mat according to any one of the preceding claims, wherein the tufted fibre layer is bonded to a rubber backing layer.

20. A mat according to any one of the preceding claims, wherein the mat is a washable dust control mat.

21. A process for manufacturing mats, in which a first yarn and a second yarn are tufted onto a substrate to produce a tufted fibre layer, wherein the first yarn is a twisted synthetic yarn and the second yarn is a blended yarn that includes at least three different fibres, including a moisture absorbing fibre, a fibre having anti-microbial properties and a low melting point fibre, the low melting point fibre is a low melting point polyester fibre that has a melting temperature of approximately 110C, and wherein the low melting point polyester fibre is at least partially fused to the moisture absorbing fibre and the fibre having anti-microbial properties.

22. A process according to claim 21, wherein the mat is pressed in a heated press to fuse the low melting point fibre at least partially to the moisture absorbing fibre and the fibre having anti-microbial properties, and the pressed mat is laundered to raise the pile of the fabric layer.

23. A process according to claim 22, wherein the fabric layer is bonded to a rubber backing layer in the heated press.

24. A process according to claim 21 or claim 22, wherein the press is heated to a temperature in the range 150-200C, preferably approximately 170C.

25. A process according to any one of claims 21 to 24, wherein the mat is pressed in the heated press for a time in the range 4-30 minutes, preferably approximately 20 minutes.

26. A mat made by a process according to any one of claims 21 to 25, wherein said mat has a substrate and a tufted pile, characterised in that the tufted pile includes tufts of a first yarn and tufts of a second yarn, wherein the first yarn is a twisted synthetic yarn, and the second yarn is a blended yarn that includes at least three different fibres, including a moisture absorbing fibre, a fibre having anti-microbial properties and a low melting point fibre, and wherein the low melting point fibre is a low melting point polyester fibre that has a melting temperature of approximately 110C and is at least partially fused to the moisture absorbing fibre and the fibre having anti-microbial properties.
